(19) United States
(12) Patent Application Publication
(10) Pub. No.: US 2022/0250084 A1
(43) Pub. Date: Aug. 11, 2022

(54) GRINDING PLANT

(71) Applicant: CERTECH S.P.A. A SOCIO UNICO, 41049 SASSUOLO (MODENA) (IT)

(72) Inventor: VALTER PALLADINI, CASALGRANDE (IT)

(21) Appl. No.: 17/597,458

(22) PCT Filed: Jul. 30, 2020
(86) PCT No.: PCT/IB2020/057202

§ 371 Date: Jan. 6, 2022

(30) Foreign Application Priority Data
Jul. 31, 2019 (IT) 102019000013395

(51) Int. Cl. B02C 23/12; B02C 21/00

(52) U.S. Cl. CPC B02C 23/12; B02C 21/007

(57) ABSTRACT

A grinding plant, comprising: a first mill (10), arranged to grind a product having a greater grain size, provided with an inlet (11) and an outlet (12); a second mill (20), arranged to grind the product to a smaller grain size, provided with an inlet (21) and an outlet (22); wherein the product in outlet from the first mill (10) is fed to the second mill (20). The plant further comprises a screen (30), interposed between the two mills (10, 20).

The present invention relates to a grinding plant, in particular but not exclusively for grinding raw ceramic materials.

As is known, powders for the production of ceramic tiles are obtained through a grinding process of raw materials in the granular state. During this process, the dimensions of the granules of the raw materials are progressively reduced, up to obtaining a predetermined grain size.

The grinding process includes the use of two or more mills which, in succession, grind the raw materials, progressively reducing the grain size thereof.

Each mill comprises a rotating hollow body, which defines a volume in which grinding bodies are arranged, immersed in a liquid, typically water. The grinding bodies have the function of grinding the material introduced into the volume itself, following the rotation of the mill about a rotation axis and during the rotation.

The best performing mills perform their grinding action in a continuous cycle. In essence, the introduction of the material to be ground and the extraction of the ground material are carried out concentrically to the axis of rotation of the mill, so that the hollow body can be kept in continuous rotation.

During operation of the mill, the grinding bodies are cyclically dragged upwards by the rotation of the hollow body and fall down once it reaches a position of maximum height, progressively grinding the product which is crushed between the grinding bodies which impact against one another.

The grain size obtained at the outlet of each mill substantially depends on the dimension of the grinding bodies. The smaller the dimension of the grinding bodies, the smaller the grain size of the product in outlet from the mill.

The mills that make up the grinding plant are located in succession, in a descending order of grain size. In substance, the product to be ground is fed to the various mills in succession from the mill provided with grinding bodies of greatest dimension to the mill provided with grinding bodies of smallest dimension.

The product in outlet from each mill, and in particular in outlet from the initial mills, i.e. the mills provided with the grinding bodies of greater dimension, does not normally have a homogeneous grain size. In particular, a percentage consisting in the product in outlet from the mill has a greater grain size with respect to what is theoretically expected. This is due to the shape of the grinding bodies which, on entering into contact with one another, leave in all cases empty spaces in which the product is not ground.

The part of product provided with greater grain size than what is expected in outlet from a certain mill represents a drawback for the successive grinding steps, i.e. for the grinding carried out by the successive mill. The successive mill is in fact provided with smaller grinding bodies with respect to the preceding mill. The larger-dimension particles significantly slow down the grinding process as they require a longer time to be reduced in grain size. Further, the grinding bodies, while working on particles of larger dimensions with respect to what was expected, are subject to degradation due to wear that is much more rapid than normal.

The object of the present invention is to provide a grinding plant which enables the drawbacks of the currently available devices to be obviated.

An advantage of the plant according to the present invention is that it enables a significant reduction of the overall times of the grinding process.

A further advantage of the plant of the present invention is that it significantly reduces wear on the grinding bodies of the mills that are successive to the first of the plant.

Further characteristics and advantages of the present invention will become more apparent in the following detailed description of an embodiment of the present invention, illustrated by way of non-limiting example in the attached figures, wherein:

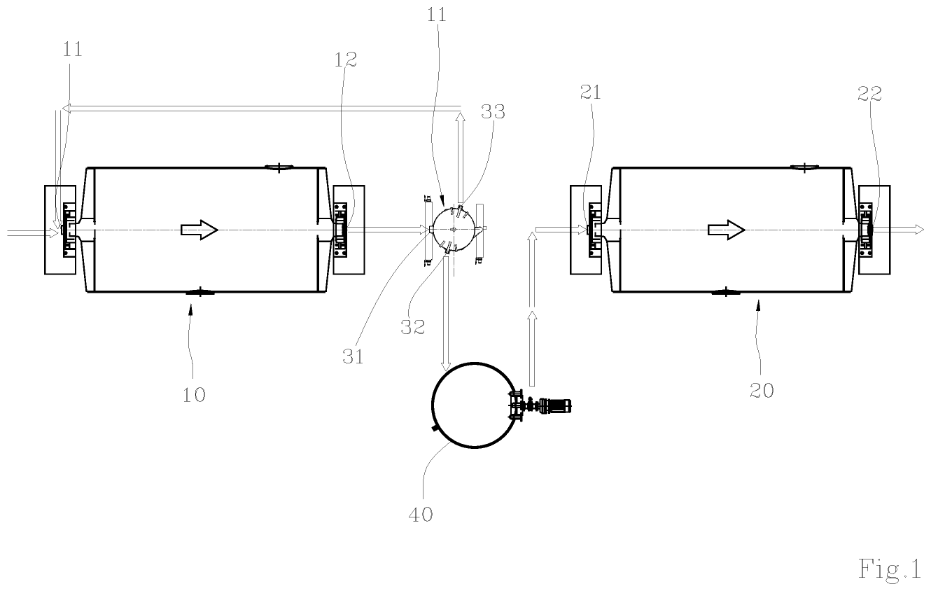

FIG. 1 schematically illustrates a first embodiment of the plant according to the present invention;

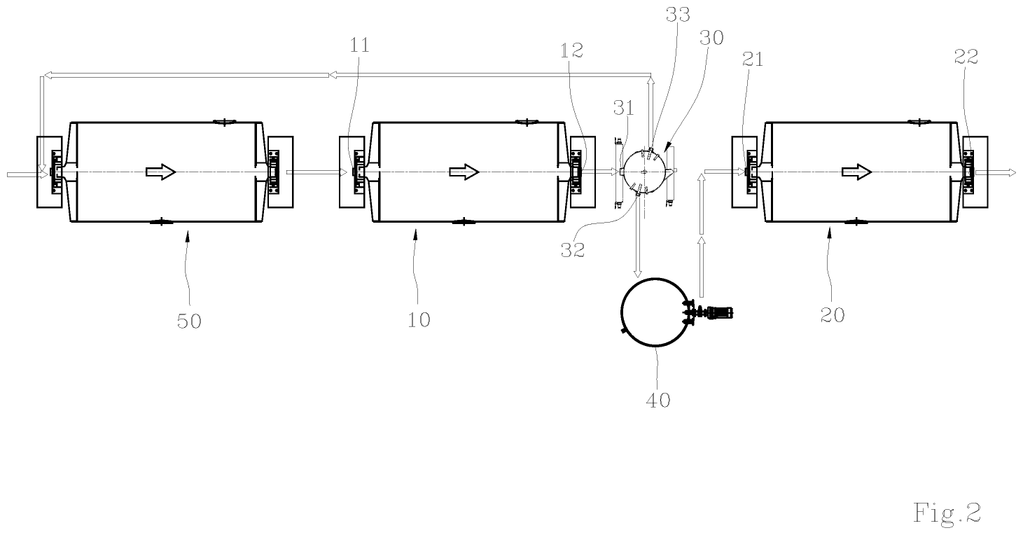

FIG. 2 schematically illustrates a second embodiment of the plant according to the present invention.

In a simpler embodiment, the grinding plant of the present invention comprises two mills (10, 20) connected in series to one another. The ground product from the first mill (10) is fed to the second mill (20).

The first mill (10) is arranged to grind the product to a greater grain size. In other terms, of the two mills, the first one (10) is provided with grinding bodies having larger dimensions than those in the second mill (20). The first mill (10) is provided with an inlet (11) for the product to be ground and with an outlet (12) for the ground product. Preferably, though not necessarily, the first mill (10) is a continuous mill, with an inlet (11) and outlet (12) that are coaxial to the rotation axis of the mill itself. The first mill (10) might also be of a discontinuous type.

A second mill (20) is arranged to grind the product to a smaller grain size. For this purpose, the second mill (20) is provided with grinding bodies having smaller dimensions with respect to the first mill (10). The second mill (20) is thus suitable for carrying out a finer grinding of the product with respect to the first mill (10). The second mill (10) is also provided with an inlet (21) for the product to be ground and with an outlet (22) for the ground product. Preferably, though not necessarily, the second mill (20) is a continuous mill, with an inlet (21) and outlet (22) that are coaxial to the rotation axis of the mill itself. The second mill (20) might also be of a discontinuous type.

The first and second mill are not necessarily of the same type, but one could be continuous and the other discontinuous.

A supply circuit, comprising one or more pumps and appropriate conduits, is arranged to feed the product to the first mill (10) and, possibly, to transfer the product from the first mill (10) to the second mill (20). In general, the supply circuit of the plant is known to the technical expert in the sector and is therefore not illustrated in detail herein.

In the grinding plants of the prior art, the product in outlet from the first mill (10) is fed to the second mill (20), either via a direct connection between the two mills, through a connecting conduit, or via a collecting tank, interposed between the two mills (10, 20), substantially without undergoing intermediate work processes. As mentioned in the foregoing, the grain size of the product in outlet from the first mill (10) is not uniform, but a not-insignificant percentage of the product has a greater grain size than what is expected, as it has not been completely ground. The product with the greater grain size, i.e. the product that has not undergone a complete grinding, is in any case fed to the second mill (20), thus slowing down the grinding operations.

In the plant according to the present invention, a screen (30) is interposed between the first mill (10) and the second mill (20). The screen (30), per se well known in the sector, comprises at least one screening net provided with mesh the dimensions of which are such as to let only the particles having smaller dimensions than the mesh pass through. As is known, the screening net is set in vibration by vibrating means.

The screening net can have a circular or quadrangular shape. In the case of a circular shape, the product is fed to the central zone of the screening net. The screening net is associated to vibrating motors which cause vibration in space, so as to transmit a vibratory motion with a vertical component and a horizontal advancement component on the material. In this way the particles that remain on the screening net advance with a spiral motion from the centre towards the periphery of the net. Along the path, the particles having smaller dimensions than what is predetermined pass through the screening net and fall into a lower zone of the screen from which they are evacuated, together with the liquid part of the suspension, towards further steps of the process, while the particles having larger dimensions, which remain on the screening net, are unloaded from a peripheral edge thereof. Examples of screens suitable to be used in the plant of the present invention are described in the Italian patent applications 102017000060477 and 102018000002719.

The screen (30) is provided with an inlet (31), through which the product in outlet from the first mill (10) is fed. For this purpose, the inlet opening (31) of the screen (30) is connected, via a conduit, to the outlet (12) of the first mill (10).

The screen (30), in a known way, is further provided with at least two outlets (32, 33). A first outlet (32) leads the screened product outside, that is the product the grain size of which allows the passage through the screening net. A second outlet (33) leads the non-screened product outside, i.e. the product the grain size of which does not allow the passage through the screening net.

The first outlet (32) of the screen (30) is advantageously connected to the inlet (21) of the second mill (20). In this way, only the product the grain size of which allows the passage through the screening net is fed to the second mill. Differently, the product having larger grain size is intercepted by the screen (30) so that it is not fed to the second mill (20). Thanks to the screening of the product, the second mill (20) works in optimal conditions, in the presence of a product the grain size of which is optimal in relation to the dimension of the grinding bodies present in the second mill (20). The Applicant has observed that, thanks to the presence of the screen (30), the productivity of the second mill (20) increases by about 20%. Further, the working life of the grinding bodies increases considerably.

The smaller the dimensions of the grinding bodies, the more efficient the operation of the screen (30) is. The production advantage offered by the presence of the screen (30) is therefore greater when the screen (30) is located in inlet to a mill adapted to carry out a fine grinding by means of grinding bodies of small dimensions, such as for example a refining mill.

The second outlet (33) of the screen (30) is connected to the inlet (11) of the first mill (10). In substance the part of the product having greater grain size, which has not passed through the screening net, is recycled to the inlet (11) of the first mill (10) in order to undergo further grinding.

A collecting tank (40) can be interposed between the first outlet (32) of the screen (30) and the inlet (21) of the second mill (20), to collect the screened material before it is introduced into the second mill (20). The collecting tank (40) substantially carries out the function of a buffer of the production cycle, separating the flow rate produced by the screen (30) to the first outlet (32) from the flow introduced into the second mill (20).

In the embodiment of FIG. 2, there are three mills, illustrated in order of growing refinement from left to right. In substance, the theoretical grain size in outlet from each mill decreases from left to right. In this case, the second mill (20) is provided with the grinding bodies of a smallest dimension, so as to produce the smallest grain size of the plant and is the last in the series. The first mill (10) is preceded by a further mill (50) which carries out a rougher grinding, i.e. it is provided with grinding bodies having larger dimensions than the first mill (10). The screen (30) is located upstream of the second mill (20) and downstream of the first mill (10).

In general, the plant can be provided with three or more mills, connected to one another in series. In that case, the plant comprises one or more further screens, each of which is interposed between two consecutive mills. Each mill can be of a continuous or discontinuous type, independently of the others, i.e. the plant can comprise two or more mills that are continuous or discontinuous, not necessary all of the same type.

1. A grinding plant, comprising:
a first mill (10), arranged to grind a product having a greater grain size, provided with an inlet (11) and an outlet (12);
a second mill (20), arranged to grind the product to a smaller grain size, provided with an inlet (21) and an outlet (22);
wherein the product in outlet from the first mill (10) is fed to the second mill (20);
characterised in that:
it comprises a screen (30), provided with an inlet (31) and two outlets (32, 33), wherein a first outlet (32) receives the screened product and a second outlet (33) receives the non-screened product the inlet (31);
the inlet opening (31) of the screen (30) is connected to the outlet (12) of the first mill (10);
the first outlet (32) of the screen (30) is connected to the inlet (21) of the second mill (20);
the second outlet (33) of the screen (30) is connected to the inlet (11) of the first mill (10).

2. The grinding plant according to claim 1, comprising a collecting tank (40) interposed between the first outlet (32) of the screen (30) and the inlet (21) of the second mill (20).

3. The grinding plant according to claim 1, comprising a third or more further mills, connected in series to the first mill (10) or to the second mill (20).

4. The plant according to claim 3, comprising one or more further screens, each of which is interposed between two consecutive mills.

5. The plant according to claim 1, wherein each mill is a continuous mill or a discontinuous mill, independently of the other.

6. The plant according to claim 1, comprising a supply circuit, provided with one or more pumps and with conduits, arranged to supply and/or circulate the product between the mills present in the plant.
